(19) United States
(12) Patent Application Publication
(10) Pub. No.: US 2017/0288600 A1
(43) Pub. Date: Oct. 5, 2017

(54) Solar Siding

(71) Applicant: Darius K. Johnson, Kansas City, MO (US)

(72) Inventor: Darius K. Johnson, Kansas City, MO (US)

(21) Appl. No.: 15/084,284

(22) Filed: Mar. 29, 2016

(51) Int. Cl. H02S 20/22

(52) U.S. Cl. CPC H02S 20/22

(57) ABSTRACT

A wall mounting solar panel encasing comprising a plurality of energy conversion devices embedded on the solar panel encasing that is constructed from a plurality of building materials such as wood, plastic, aluminum, vinyl, rock or concrete and provides appealing designs matching to building structures. The solar panel housed with a series of energy conversion devices that provide transformed electrical energy. The solar panel encasing is mountable in a horizontal, vertical or inclined manner depending upon the building architecture. A solar encasing housed with solar panels, carrying a series of solar cells. The structure of solar encasing provides a number of applications to contribute to uninterrupted electrical energy generation and generating power independent building structures.

### CROSS-REFERENCE TO RELATED APPLICATIONS

Not applicable.

### STATEMENT REGARDING FEDERALLY SPONSORED RESEARCH OR DEVELOPMENT

Not applicable.

### NAMES OF THE PARTIES TO A JOINT RESEARCH AGREEMENT

Not applicable.

### INCORPORATION-BY-REFERENCE OF MATERIALS SUBMITTED ON A COMPACT DISC

Not applicable.

### BACKGROUND OF THE INVENTION

### 1. Field of the Invention

A wall mounting solar panel encasing along with a plurality of energy conversion devices embedded on the solar panel encasing that is constructed from a plurality of building materials, specifically designed for mounting vertically on the building walls.

### 2. Description of Related Art Including Information Disclosed Under 37 CFR 1.97 and 37 CFR 1.98.

The demand for renewable energy resources is increasing day by day. The solar energy is one of the renewable energy resources which can be converted into electrical energy with the help of photo voltaic cells. The solar cells generally mounted on the roof tops of the tall structures or need an open area for receiving ambient light energy to produce electrical energy. With increasing energy demand and less open spaces it is very difficult to install solar panels everywhere either on the roof tops or on the outskirts. Installation of solar cells requires connecting electrodes with panels and multiple panels can be connected in series and parallel to provide a stand-alone system or networked system. Many improvements have been developed in this field to help in increasing efficiency by converting more solar energy into electricity. To enhance efficiency and easy construction of solar panels a number of inventions are known in the prior arts.

One prior art U.S. Pat. Appl. No. 20140260000 A1 entitled to Andrew Leo Haynes et al. discloses a module that can be used as part of a thermal energy recovery or removal system and also bears an array of solar cells to generate electrical energy from solar energy.

Similarly, U.S. Pat. Appl. No. 20080302031 A1 entitled to Peter Bressler et al. discloses a seamless application with any conventional profile tile because the solar panel is advantageously embodied in a shape and size of a conventional profile tile. A concrete low-profile tile or a profile tile constructed from other materials or in other shapes. The size and shape of the profile solar panel tile enables the same roofing mechanic who installs the conventional roofing tiles to install the profile solar panel tile without any special tools or fasteners. The profile solar panel tiles have crests and valleys that conform to the crests of valleys of conventional tiles in adjacent courses. The profile solar tiles also interlock with or overlap with adjacent conventional tiles when installed in the same course. The adjacent tiles may be other profile solar panel tiles or conventional profile roofing tiles.

Similarly, U.S. Pat. Appl. No. 20080000512 A1 entitled to Brian J. Flaherty et al. discloses an integrated solar roofing tile connection system for installing on a roof surface and converting solar energy into electrical energy. The integrated solar roofing tile connection system includes a plurality of battens that each have a length and are mounted to the roof surface. The plurality of battens is generally parallel to and spaced from one another. A plurality of electrically connected female connectors mounted to each batten and spaced along the length of each batten. A plurality of photovoltaic roofing tiles is mounted to each batten. Each photovoltaic roofing tile has a tile base that has a first side surface, a second side surface and a top edge and a photovoltaic circuit.

It is an aspect of the invention to overcome or alleviate a problem of the prior art. This permits the use of the present invention which enhance the prior art of the system of installing solar panels on structural units of residential and commercial buildings to provide electricity from sun light efficiently.

### BRIEF SUMMARY OF THE INVENTION

In view of the foregoing, one aspect of the various disclosed embodiments in the present invention is to provide a solar panel encasing on any building structure that collects solar energy, converts it into electrical energy and stores the converted energy into storage units. A method is disclosed for transforming concrete buildings into power buildings by installing photovoltaic panels on the solar encasings, capable of generating electricity on the walls of the buildings. A solar panel structure that save money and releases stress on increasing electrical grid. The photovoltaic panels are encased in an encasing made of any kind of building material like wood, vinyl aluminum, rock, concrete etc.

These solar encasings can be mounted at any location where a typical solar panel is seems to be inefficient. Usually the scope of typical solar panels was limited to roof tops only but solar sliding allows solar panels to be fixed to the exterior of any building structure or on the billboards. The solar panel encasing can be made and installed in a manner to resemble traditional lap or other exterior siding such as curtain wall types. The solar panels can be encased in many different building materials such as wood, vinyl, aluminum, rock and concrete or any other material for residential or commercial use. The photovoltaic panels installed on the side walls housed in the solar panel encasing become appealing in association with part of building design.

Solar panel siding is an improved photovoltaic panel design for use of structural applications. The panels can be placed in any building materials to look like traditional lap or other exterior siding such as curtain wall types. The application can also be installed on skyscrapers, bridges and billboards like structures. Depending on the shape and size of the building the panels can be constructed in a numbers of varieties, shapes and sizes.

Other objects of the present invention will become apparent from time to time throughout the specification as hereinafter related.

In this respect, before explaining at least one embodiment of the invention in detail, it is to be understood that the invention is not limited in its application to the details of construction and to the arrangements of the components set forth in the following description. The invention is capable of other embodiments and of being practiced and carried out in various ways. Also, it is to be understood that the phraseology and terminology employed herein are for the purpose of description and should not be regarded as limiting.

These together with other objects of the invention, along with the various features of novelty which characterize the invention, are pointed out with particularity in the disclosure. For a better understanding of the invention, its operating advantages and the specific objects attained by its uses, reference should be had to the descriptive matter in which there are illustrated preferred embodiments of the invention.

### BRIEF DESCRIPTION OF THE SEVERAL VIEWS OF THE DRAWINGS

The invention will be better understood and objects other than those set forth above will become apparent when consideration is given to the following detailed description thereof. Such description makes reference to the annexed drawings wherein:

FIG. 1 is a general perspective view of the solar panels encasing in accordance with the present invention.

FIG. 2 is a schematic representation of solar panels.

### DETAILED DESCRIPTION OF THE INVENTION

The following detailed description of the present invention is enabling teaching of the invention and its best, currently known embodiment. Those skilled in the art can understand that many changes can be made in the embodiments described, while still obtaining beneficial results of the present invention. It will also be apparent that some of the desired benefits of the present invention can be obtained by selecting some of the features of the invention while not utilizing other features. Accordingly, those working in the relevant art will recognize that many adaptations and modification to the present invention can be made and may be desired in certain circumstances, and are part of the present invention. Thus, the following description is provided as illustrative of the principle of the present invention.

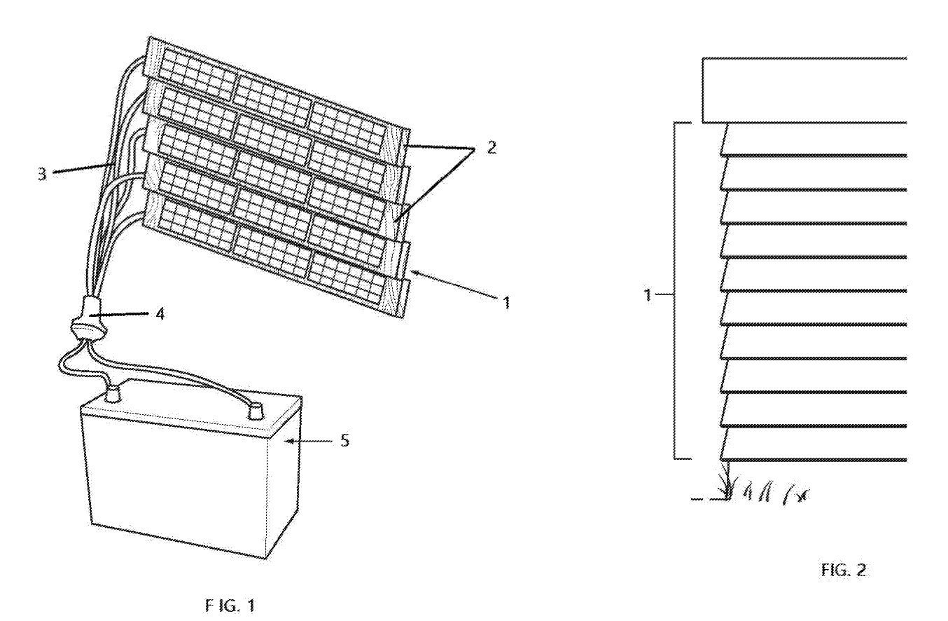

Referring to FIG. 1 describes various components of the invention. A series of solar cells (1) housed in an encasing panel (2) that is made up of any building material like wood, aluminum, concrete, rock, plastic, metal or combination thereof. The series of cells (1) connected to a coupler circuit (4) through connecting wires (3). The coupler (4) combines the output from the network of solar cells (1) and provided only two terminals output that is ready to connect to a rechargeable battery (5). The solar encasing panel (2) structure can be designed in a variety of manners and with different structures and compositions.

In one of the embodiment of the present invention the solar panels connected in a network arrangement and output from these is utilized in the form of heat energy.

The solar panel sidings provides a clean source of energy and these can be installed on side walls, curtain laps, doors, windows etc. of a building also yielding the latest designs to provide tempting effects. The energy generated is used either in recharging storage batteries or provided directly to electrical grids.

The construction of the solar panel siding is providing a long life of the panels with easy to withstand extreme hot and cold climatic conditions such as temperature, pressure, humidity and rain resulting in a long lasting life of the panels.

Accordingly, the specific embodiments discussed herein are merely illustrative of specific manners in which to make and use this invention, and are not intended to represent an exhaustive list of all possible structure and processes of the present invention.

Embodiments of the system for solar panel siding are discussed below. While the structure and processes have been described with a certain degree of particularity, it is to be noted that many modifications may be made in the details of the structure and processes without departing from the spirit and scope of this disclosure. It is understood that the structure and processes are not limited to the embodiments set forth herein for purposes of exemplification.

The present invention provides a wall mountable solar panel siding structures that is designed to house a number of photovoltaic cells, the structure is mountable in vertical or inclined position dependent on the structural requirements.

In one of the embodiment of the invention the solar panel encasing can be constructed in combination with the building structure and solar panels installed on the constructed panels accordingly. The solar panels fitted in this manner can be detachable for fault repair or replacement purposes.

The disclosed system can be executed on one or more bridges or billboards standing on the roadsides and can become power independent by installing solar panels on these structures.

While the above description regarding illustrative embodiments of the disclosed system includes examples of solar panel siding, the present invention is not limited to those specific examples. Accordingly, those skilled in the art will recognize that alternative embodiments may use any specific type or kind of material or structural designs to enhance the efficiency that may be appropriate.

It is to be understood that the above description is intended to be illustrative, and not restrictive. For example, the above discussed embodiments may be used in combination with each other. Many other embodiments will be apparent to those of skill in the art upon reviewing the above description.

Whereas, the construction and method have been described in relation to the above-given embodiments, it should be understood that other and further modifications, apart from those shown or suggested herein, may be made within the spirit and scope of this invention. The different components may be designed to achieve the objective separately or in combination thereof.

I claim:

1. A wall mounting solar panel encasing comprising:
a plurality of energy conversion devices embedded on said solar panel encasing;

2. The solar panel encasing on a building of claim 1, wherein said solar panel encasing constructed from a plurality of building materials.

3. The solar panel encasing on a building of claim 1, wherein said solar panel encasing is mountable in a manner selected from a group of horizontal, vertical or inclined manner.
